(19) United States
(12) Patent Application Publication
(10) Pub. No.: US 2026/0315913 A1
(43) Pub. Date: Oct. 15, 2026

(54) GAME CONTROLLER

(71) Applicant: Junlin PAN, BEIJING (CN)

(72) Inventor: Junlin PAN, BEIJING (CN)

(21) Appl. No.: 19/547,142

(22) Filed: Feb. 23, 2026

Related U.S. Application Data
(63) Continuation of application No. PCT/CN2024/094573, filed on May 21, 2024.

(30) Foreign Application Priority Data
Aug. 24, 2023 (CN) 202322286873.0

(51) Int. Cl. A63F 13/24; G06F 3/0354

(52) U.S. Cl. CPC A63F 13/24; G06F 3/03543

(57) ABSTRACT

The present application relates to the technical field of mice, in particular to a game controller, comprising a mouse body. The mouse body is provided with a composite control surface and a bottom surface. The composite control surface is provided with at least two sub-regions with different surface roughness. At least two points, are arranged in the composite control surface. At least two surfaces, namely a first contact surface and a second contact surface, are arranged in the composite control surface, the first marker point is located in the first contact surface, and the second marker point is located in the second contact surface. The present application enables a single finger to apply a lateral control force and a vertical pressure to the mouse, improves the control precision of the finger on the mouse, and relieves fatigue of the finger caused by long-term use.

### RELATED APPLICATION

The present application claims priority of Chinese utility model application No.202322286873.0, which is titled “Game Controller” and filed on Aug. 24, 2023.

### TECHNICAL FIELD

This invention belongs to the field of mouse technology, specifically, it relates to a game controller.

### BACKGROUND

The mouse is an extremely important human-computer interaction device in computer field, which can simplify instruction input. With the increasing applying of computers in various fields of work and life, long time operation of the mouse is becoming more and more common.

When person operates a mouse, the thumb is usually in contact with the left side of the mouse, the index and middle fingers are placed on buttons of the mouse, the palm is in contact with the top surface of the mouse, the ring finger and little finger are placed on right side vertically, and the position of placement of the thumb on the mouse directly determines the horizontal and vertical control force exerted by the fingers on the mouse. The existing mouse is designed with a smooth transition, with only finger belly of the thumb touching the left side of the mouse. Prolonged operation can cause finger fatigue and reduced mouse controlling ability, leading to paralysis, swelling, pain, and spasms in the wrist muscles or joints, especially for professional gamers. Therefore, a mouse is needed to address the existing shortcomings.

### SUMMARY

The present application proposes a game controller that addresses the shortcomings in the prior art. The game controller has a composite control surface, which has a first contact surface and a second contact surface. The roughness of the first contact surface is greater than that of the second contact surface, resulting in a higher frictional force on the first contact surface of the mouse as compared to the second contact surface, ensuring that the fingers can provide sufficient lateral control force, while a lower frictional force of the second contact surface ensures that the first contact surface does not interfere with the second contact surface, decoupling the horizontal and vertical control forces applied by the fingers to the mouse, improving the control accuracy of the fingers on the mouse, and alleviating fatigue caused by long-term use of the fingers.

To achieve the above objectives, the present application provides a game controller, comprising a mouse body, wherein the mouse body having a composite control surface and a bottom surface; a composite control surface is a continuous plane or curved surface, or a combination of multiple discontinuous planes or curved surfaces; the composite control surface has at least two sub regions with different surface roughness;
the bottom surface is a continuous plane or curved surface, or a combination of multiple discontinuous planes or surfaces, wherein an area is provided on the bottom used for a mouse displacement sensor to receive optical energy so that it work normally;
there are at least two points within the composite control surface, namely a first marker point and a second marker point, and there is at least one set of non collinear three points on the bottom surface, which form the reference bottom surface; a first acute angle between the normal direction of the surface corresponding to the first marker point and the reference base surface is less than 60°, and a second acute angle between the normal direction of the surface corresponding to the second marker point and the reference base surface is greater than 45°;
the composite control surface includes at least two surfaces, namely the first contact surface and the second contact surface, with the first marker point located within the first contact surface and the second marker point located within the second contact surface.

Furthermore, the roughness of the first contact surface is different from the second contact surface.

Furthermore, the roughness Ra of the first contact surface is greater than Ra 0.1 μm, and the roughness Ra of the second contact surface is less than Ra 5.0 μm.

Furthermore, the roughness of the first contact surface is greater than that of the second contact surface, and the roughness Ra of the second contact surface is less than Ra 3.0 μm.

Furthermore, the roughness of the first contact surface is greater than that of the second contact surface, and the roughness Ra of the second contact surface is less than Ra 0.5 μm.

Furthermore, the roughness of the first contact surface is greater than that of the second contact surface, and the roughness Ra of the second contact surface is less than Ra 0.3 μm.

Furthermore, the composite control surface has a transition area with a curvature radius less than 15 mm, which is set between the first contact surface and the second contact surface, and used to separate the first contact surface and the second contact surface.

Furthermore, the composite control surface has a transition area with a curvature radius less than 5 mm, which is set between the first contact surface and the second contact surface to separate the first contact surface and the second contact surface.

Furthermore, the mouse body comprises a side portion and a support plate, with the first contact surface located on the surface of the side portion and the second contact surface located on the surface of the support plate.

### Technical Effects

Firstly, the mouse body of the present application has a composite control surface and a bottom surface, and there are at least one first contact surface and at least one second contact surface in the composite control surface. The first contact surface contains at least one first marker point(s), and the second contact surface contains at least one second marker point(s). A acute angle formed between the normal direction of the surface corresponding to the first marker point and the reference bottom surface of the bottom surface is less than 60°, and a acute angle formed between the normal direction of the surface corresponding to second marker point and the reference bottom surface of the bottom surface is greater than 45°. By setting the roughness of the first contact surface being greater than that of the second contact surface, the first contact surface of the mouse marker provides high friction force, ensuring that fingers can provide sufficient lateral control force to it. The low friction force of the second contact surface can ensure that it mainly generates longitudinal pressure during use and provides relatively small lateral force, to ensure that the forces exerted by the first and second contact surfaces do not interfere/conflict with each other, and to decouple the horizontal and vertical control forces exerted by the fingers on the mouse, thereby improving the precision of finger control over the mouse and relieving finger fatigue from prolonged use;

Secondly, in the preferred implementation method, the roughness of the first contact surface of the mouse of the present application is greater than that of the second contact surface, and the roughness of the second contact surface is less than Ra 0.3 μm. By further constraining the roughness of the second contact surface, the friction force of the second contact surface is reduced, further improving the precision of finger control over the mouse.

In the preferred implementation, the composite control surface of the present application has a transition area with a curvature radius of less than 15 mm, which separates the first contact surface and the second contact surface to form a clear boundary, providing clear tactile feedback and facilitating operation.

### BRIEF DESCRIPTION OF DRAWINGS

FIG. 1 is a three-dimensional structural diagram of the game controller of the present application;

FIG. 2 is a top view of the game controller of the present application;

FIG. 3 is a cross-sectional view of A-A of the game controller of the present application;

FIG. 4 is a three-dimensional structural diagram of the mouse body of the present application.

### FIGURE MARKERS

1 Mouse body;
10 Side Portion;
11 Tray;
100 composite control surface;
Bottom surface;
2 Button;
3 Top cover;
A first marker point;
B second marker point.

### Embodiments

In order to enable those skilled in this field to better understand the technical solution of the present application, detailed explanations of the present utility model in conjunction with the accompanying drawings and embodiments are provided below.

The terms used for directions such as up, down, left, right, front, and back in this application document are based on the positional relationships shown in the attached drawings. If the attached drawings are different, the corresponding positional relationships may also change accordingly, so this cannot be understood as a limitation on the scope of protection.

In this application, the terms “installation”, “connection”, “joining”, “connection”, “fixation”, etc. should be broadly understood. For example, they can be fixed connections, detachable connections, integrated connections, mechanical connections, electrical connections, or can communicate with each other. They can also be direct connections, indirect connections through intermediate media, internal connections between two components, or the interaction relationship between two components. For ordinary technical personnel in this field, the specific meanings of the above terms in this application can be understood according to the specific situation.

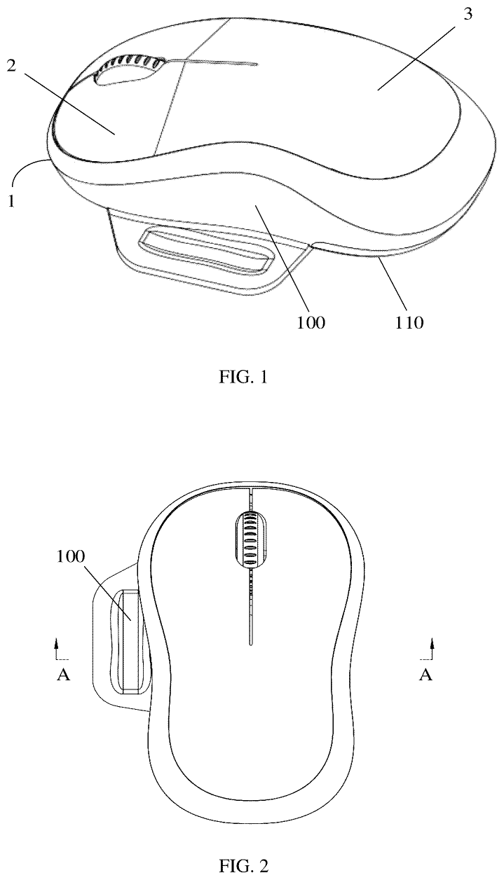

Referring to FIGS. 1-3, the game controller of this embodiment includes a mouse body 1, buttons 2, and a top cover 3. The top portion of top cover 3 has a continuous curved surface used to support the palm of user. At one end of the top cover 3, it is equipped with button(s) 2, which includes a left button and a right button. Under the top cover 3, it is equipped with the mouse body 1, which is used to install electronic components inside.

Mouse body 1 has a composite control surface 100 and a bottom surface 110, both of which are continuous planes or curved surfaces, or a combination of multiple discontinuous planes or curved surfaces. The bottom surface 110 has an area for setting/installing the mouse displacement sensor to receive optical energy for normal operation.

There are at least two points within the composite control surface 100, namely a first marker point and a second marker point. The bottom surface 110 has at least one set of three non collinear points, which form the reference bottom surface. The acute angle formed between the normal direction of the surface corresponding to first marker point and the reference bottom surface is less than 60°, and the acute angle formed between the normal direction of the surface corresponding to second marker point and the reference bottom surface is greater than 45°. There are at least two surfaces within composite control surface 100, namely a first contact surface and a second contact surface, wherein the first marker point is located within the first contact surface, and the second marker point is located within the second contact surface.

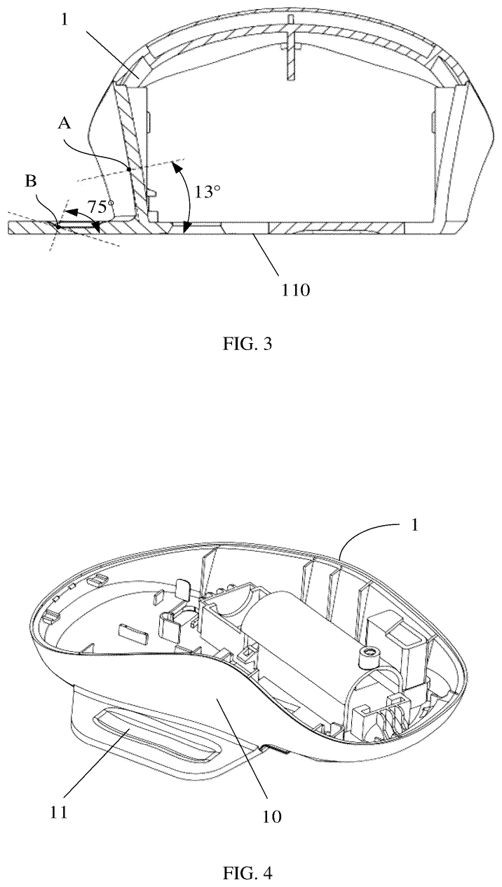

Taking the statement shown in FIG. 3 as an example, point “A” is a first marker point, and point “B” is a second marker point. Point “A” is located within the first contact surface, and point “B” is located within the second contact surface. Both the first and second contact surfaces are located within the composite control surface 100, and the bottom surface 110 has a reference bottom surface composed of three non col-linear points. A acute angle between the normal direction of surface A and the reference base is 13°, while the acute angle between the normal direction of surface B and the reference base is 75°.

In one embodiment, the composite control surface 100 has a transition area with a curvature radius of less than 15 mm, which is set between the first contact surface and the second contact surface to separate them.

In another implementation, the composite control surface 100 has a transition area with a curvature radius of less than 5 mm, which is set between the first contact surface and the second contact surface to separate them.

Preferably, there is a roughness difference between the first contact surface and the second contact surface, with the roughness Ra of the first contact surface being greater than Ra 0.1 and the roughness Ra of the second contact surface being less than Ra5.0.

In one implementation, the roughness of the first contact surface is greater than that of the second contact surface, and the roughness Ra of the second contact surface is less than Ra 3.0 μm. In another implementation, the roughness of the first contact surface is greater than that of the second contact surface, and the roughness Ra of the second contact surface is less than Ra 0.5 μm.

In another implementation, the roughness of the first contact surface is greater than that of the second contact surface, and the roughness Ra of the second contact surface is less than Ra 0.3 μm.

The material used for the first contact surface can be plastic or carbon fiber board. The materials used for the second contact surface can be glass, carbon fiber board, artificial sapphire, silicon nitride ceramic, and silicon carbide ceramic.

In a preferred implementation, the roughness requirements of the first and second contact surfaces in this embodiment can be achieved by spraying materials on the surfaces of the first and second contact surfaces. The skilled in this field should understand that the surface roughness of the first contact surface and the second contact surface can be made/achieved by different design methods.

The game controller also includes a central scroll wheel and a battery cover. The central scroll wheel is installed on top cover 3, between the left and right buttons of button 2, and the battery cover is installed at the bottom of mouse body 1.

In one embodiment, referring to FIG. 4 of the specification, the mouse body 1 includes a side portion 10 and a support plate 11. Side portion 10 is located on one side of the mouse body 1 and matches the thumb activity area, with a support plate 11 extending outward from the lower edge of side 10.

The first contact surface is located within the side portion 10 (or used as at least part of surface of the side portion 10), the second contact surface is located within the support plate 11 (or used as at least part of surface of the support plate 11), and the first contact surface of the side portion 10 and the second contact surface of the support plate 11 are located within the composite control surface 100 of the mouse body 1.

The game controller of this embodiment can be placed on a platform through the bottom surface 110, when a user holds the mouse body 1, the palm is in contact with the continuous curved surface at the top of the top cover 3, the finger pad of thumb is in contact with the first contact surface, and the outer side of the thumb is in contact with the second contact surface, allowing a single finger to simultaneously apply horizontal control force and vertical pressure to the mouse.

By adopting the structure of this embodiment, due to the roughness of the first contact surface is greater than that of the second contact surface, the first contact surface of the mouse has high friction with fingers, ensuring that the fingers can provide sufficient lateral control force to it. The low friction of the second contact surface ensures that the first contact surface will not interfere/disturb with the second contact surface, decoupling the horizontal and vertical control forces applied by the fingers to the mouse, improving the accuracy of finger control over the mouse, and alleviating finger fatigue caused by long-term use.

The above is only an embodiment of the present application, and the specific structures and characteristics commonly known in the scheme are not described in detail here. For those skilled in the art, it is apparent that the present utility model is not limited to the details of the exemplary embodiments described above, and can be implemented in other specific forms without departing from the spirit or basic features of the present utility model. Therefore, from any point of view, the embodiments should be regarded as exemplary and non limiting, and the scope of the present application is limited by the appended claims rather than the above description. Therefore, it is intended to include all changes falling within the meaning and scope of the equivalent elements of the claims in the present utility model. Any reference numerals in the claims should not be regarded as limiting the claims involved.

1. A game controller, comprising a mouse body, wherein the mouse body has a composite control surface and a bottom surface;
wherein the composite control surface is a continuous plane or curved surface, or a combination of multiple discontinuous planes or curved surfaces; the composite control surface has at least two sub-regions with different surface roughness;
the bottom surface is a continuous plane or curved surface, or a combination of multiple discontinuous planes or curved surfaces; the bottom surface is provided with an area, which is used for the normal operation of a mouse displacement sensor;
the composite control surface includes at least two points therein, respectively referred to as a first marker point and a second marker point, and the bottom surface includes at least one set of three non-collinear points, and the three non-collinear points defining a reference bottom surface; a acute angle formed between the normal direction of the surface corresponding to the first marker point and the reference bottom surface is less than 60°, and a acute angle formed between the normal direction of the surface corresponding to the second marker point and the reference bottom surface is greater than 45°;
the composite control surface includes at least two surfaces, which are respectively referred to as a first contact surface and a second contact surface, the first marker point is located in the first contact surface, and the second marker point is located in the second contact surface.

2. The game controller according to claim 1, wherein roughness Ra of the first contact surface is different from the second contact surface.

3. The game controller according to claim 2, wherein the roughness Ra of the first contact surface is greater than Ra 0.1 μm, and the roughness Ra of the second contact surface is less than Ra 5.0 μm.

4. The game controller according to claim 3, wherein the roughness of the first contact surface is greater than that of the second contact surface, and the roughness Ra of the second contact surface is less than Ra 3.0 μm.

5. The game controller according to claim 3, wherein the roughness of the first contact surface is greater than that of the second contact surface, and the roughness Ra of the second contact surface is less than Ra 0.5 μm.

6. The game controller according to claim 3, wherein the roughness of the first contact surface is greater than that of the second contact surface, and the roughness Ra of the second contact surface is less than Ra 0.3 μm.

7. The game controller according to claim 1, wherein the composite control surface has a transition area with a curvature radius of less than 15 mm, the transition area is disposed between the first contact surface and the second contact surface for separating the first contact surface and the second contact surface.

8. The game controller according to claim 1, wherein the composite control surface has a transition area with a curvature radius of less than 5 mm, the transition area is disposed between the first contact surface and the second contact surface for separating the first contact surface and the second contact surface.

9. The game controller according to claim 1, wherein the mouse body comprises a side portion and a support plate, the first contact surface is located on the surface of the side portion, and the second contact surface is located on the surface of the support plate.
